(19) United States
(12) Patent Application Publication
(10) Pub. No.: US 2014/0168225 A1
(43) Pub. Date: Jun. 19, 2014

(54) INFORMATION PROCESSOR AND INFORMATION PROCESSING METHOD

(71) Applicant: Kabushiki Kaisha Toshiba, Tokyo (JP)

(72) Inventors: Kazuyasu OHWAKI, Tokyo (JP); Toshio OBAYASHI, Tokyo (JP)

(21) Appl. No.: 13/917,907

(22) Filed: Jun. 14, 2013

(30) Foreign Application Priority Data
Dec. 14, 2012 (JP) 2012-274046

(51) Int. Cl. G09G 5/00

(52) U.S. Cl. CPC G09G 5/006
USPC 345/501

(57) ABSTRACT

According to one embodiment, an information processor includes an acquisition module. The acquisition module is configured to acquire a third value of a parameter based on a first value of the parameter, a second value of the parameter, and a predetermined value. The parameter is one of a brightness, a color temperature, and a color. The first value is a value of the parameter corresponding to a test chart of a display screen comprised in a captured image obtained by capturing the display screen and the background of the display screen by an image capturing module. The test chart comprises a parameter of the predetermined value. The second value is a value of the parameter of the background comprised in the captured image. The third value is a value of the parameter of the background.

### CROSS-REFERENCE TO RELATED APPLICATIONS

This application is based upon and claims the benefit of priority from Japanese Patent Application No. 2012-274046, filed Dec. 14, 2012, the entire contents of which are incorporated herein by reference.

### FIELD

Embodiments described herein relate generally to an information processor and an information processing method.

### BACKGROUND

There has been disclosed a technique in which a sensor for detecting brightness is attached to a remote controller for operating a display device, the brightness detected by the sensor attached to the remote controller is acquired, and image quality of the display device is controlled by using the acquired brightness.

The conventional technique detects the brightness of the background of the display device by using the sensor attached to the remote controller. However, the conventional technique does not describe a specific method for detecting accurate brightness of the background of the display device. For example, if a camera provided in a mobile terminal device is used as a sensor for detecting the brightness of the background of the display device, it is difficult to detect an accurate brightness because of the automatic correction functions (automatic brightness correction function, automatic white balance function, and the like) of the camera and depending on the type of the camera.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary outer appearance perspective view of one example of a television broadcast display device according to a first embodiment;

FIG. 2 is an exemplary diagram of a hardware configuration example of a mobile terminal device in the first embodiment;

FIG. 3 is an exemplary block diagram of a functional configuration of the television broadcast display device and the mobile terminal device in the first embodiment;

FIG. 4 is an exemplary flowchart of an output processing of a third value in the mobile terminal device in the first embodiment;

FIG. 5 is an exemplary view of one example of a captured image obtained through an image capturing by an image capturing module provided in the mobile terminal device in the first embodiment;

FIG. 6 is an exemplary view of one example of the captured image obtained through the image capturing by the image capturing module provided in the mobile terminal device in the first embodiment;

FIG. 7 is an exemplary graph illustrating a correspondence between captured-image RGB values and display RGB values on an RGB value conversion table stored in the mobile terminal device in the first embodiment;

FIG. 8 is an exemplary flowchart of a processing of adjusting the image quality of a display screen provided in the television broadcast display device in the first embodiment;

FIG. 9 is an exemplary diagram of a hardware configuration of a mobile terminal device according to a second embodiment;

FIG. 10 is an exemplary block diagram of a functional configuration of a television broadcast display device and the mobile terminal device in the second embodiment;

FIG. 11 is an exemplary flowchart of an output processing of a third value in the mobile terminal device in the second embodiment;

FIG. 12 is an exemplary block diagram of a functional configuration of a television broadcast display device and a mobile terminal device according to a third embodiment; and

FIG. 13 is an exemplary flowchart of an output processing of a third value in the mobile terminal device in the third embodiment.

### DETAILED DESCRIPTION

In general, according to one embodiment, an information processor comprises an acquisition module. The acquisition module is configured to acquire a third value of a parameter based on a first value of the parameter, a second value of the parameter, and a predetermined value. The parameter is one of a brightness, a color temperature, and a color. A type of the parameter of the second value and a type of the parameter of the third value are same as a type of the parameter of the first value. The first value is a value of the parameter corresponding to a test chart of a display screen comprised in a captured image obtained by capturing the display screen and the background of the display screen by an image capturing module. The test chart comprises a parameter of the predetermined value. The second value is a value of the parameter of the background comprised in the captured image. The third value is a value of the parameter of the background.

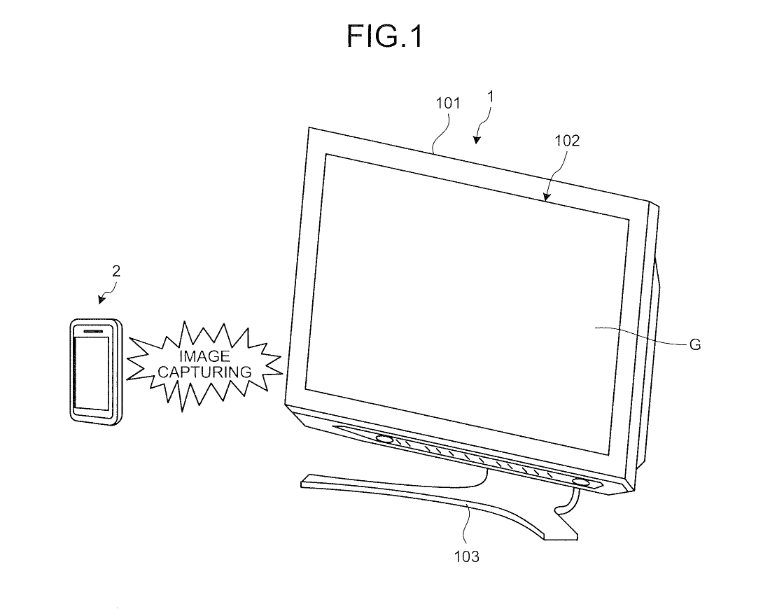

FIG. 1 is an outer appearance perspective view illustrating an example of a television broadcast display device according to a first embodiment. As illustrated in FIG. 1, this television broadcast display device 1 comprises a housing 101 and a liquid crystal display (LCD) 102. The housing 101 is supported by a support 103 and has a rectangular outer appearance when seen from the front side. The LCD 102 serving as a display module comprises a display screen G on which various pieces of information such as still images and moving images are displayed.

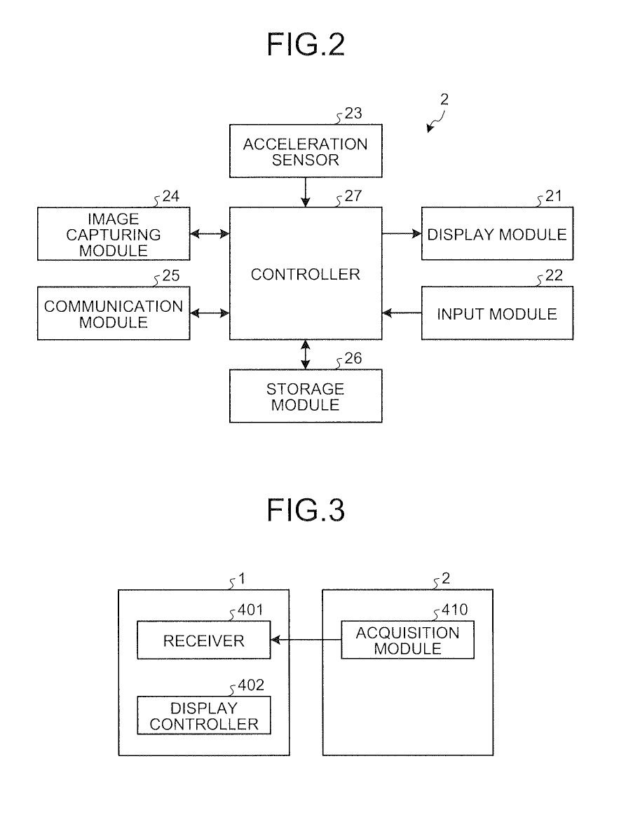

FIG. 2 is a diagram illustrating an example of a hardware configuration of a mobile terminal device in the first embodiment. As illustrated in FIGS. 1 and 2, this mobile terminal device 2 in the embodiment comprises a display module 21, an input module 22, an acceleration sensor 23, an image capturing module 24, a communication module 25, a storage module 26, and a controller 27. The mobile terminal device 2 also comprises a speaker and a microphone that are not illustrated in the drawing.

The display module 21 is a display device such as a liquid crystal display (LCD) and an organic electroluminescence (EL) display. The display module 21 displays various pieces of information under control by the controller 27.

The input module 22 is an input device such as a pointing device and a button for receiving various directions and information input by a user. In the embodiment, a touch panel is used as the pointing device. The touch panel comprises a transparent coordinate detection device arranged on the screen of the display module 21. The pointing device is not limited thereto.

The acceleration sensor 23 is a sensing device that senses acceleration applied thereto. For example, the acceleration sensor 23 outputs change (inclination and rotation) of the posture thereof in the triaxial directions, as a sensing result.

The image capturing module 24 can capture images of the display screen G and the background of the display screen G from the front side of the display screen G provided in the television broadcast display device 1.

The communication module 25 is a communication interface that can be connected to a network (not illustrated) such as the Internet. The communication module 25 transmits and receives various pieces of information to and from an external device (for example, the television broadcast display device 1) connected to the network, under control by the controller 27.

The storage module 26 comprises a non-volatile storage medium such as a read-only memory (ROM), a hard disk drive (HDD), and a solid state drive (SSD), and stores therein various types of programs, setting information, and the like.

The controller 27 comprises a central processing unit (CPU) and a random access memory (RAM) (neither of them are illustrated), and controls operations of the mobile terminal device 2 collectively in cooperation with the programs stored in the storage module 26.

Next, with reference to FIG. 3, there is described a functional configuration of the television broadcast display device 1 and the mobile terminal device 2 according to the embodiment. FIG. 3 is a block diagram illustrating the functional configuration of the television broadcast display device and the mobile terminal device in the first embodiment.

In the television broadcast display device 1, a controller (not illustrated) such as a central processing unit (CPU) executes a display control application to implement a receiver 401 and a display controller 402 as illustrated in FIG. 3. The receiver 401 receives parameter information to be used for adjusting brightness, a color temperature, and a color of the display screen G from the mobile terminal device 2. The display controller 402 adjusts the brightness, the color temperature, and the color of the display screen G based on the parameter information received by the receiver 401. In the embodiment, the display controller 402 adjusts the brightness, the color temperature, and the color of the display screen G, but parameters to be adjusted are not limited thereto. For example, the display controller 402 may adjust another parameter relating to the image quality, such as the sharpness.

The controller 27 of the mobile terminal device 2 executes a program stored in the storage module 26 so as to implement an acquisition module 410 as illustrated in FIG. 3. The acquisition module 410 acquires a third value of a parameter based on a first value of the parameter, a second value of the parameter, and a predetermined value (a value of the parameter of the test chart T). Here, the parameter is one of the brightness, the color temperature, and the color. A type of the parameter of the second value and a type of the parameter of the third value are the same as a type of the parameter of the first value. The first value is a value of the parameter corresponding to an image (in the present embodiment, corresponding to the test chart T of FIG. 5) contained in a captured image X (see FIG. 5) obtained by the image capturing of the image capturing module 24. Here, the image (in the present embodiment, corresponds to the test chart T of FIG. 5) has (is associated with) a parameter of a predetermined value. The second value is a value of the parameter of the background B comprised in the captured image X (see FIG. 5). The third value is a value of the parameter of the background B of the display screen G. The acquisition module 410 outputs parameter information indicating the third value to the television broadcast display device 1. In the embodiment, each of the predetermined value, the first value, the second value, and the third value is a value indicating a value (cd/m²) representing the brightness, a value (K) representing the color temperature, or a value (XYZ value) representing the color.

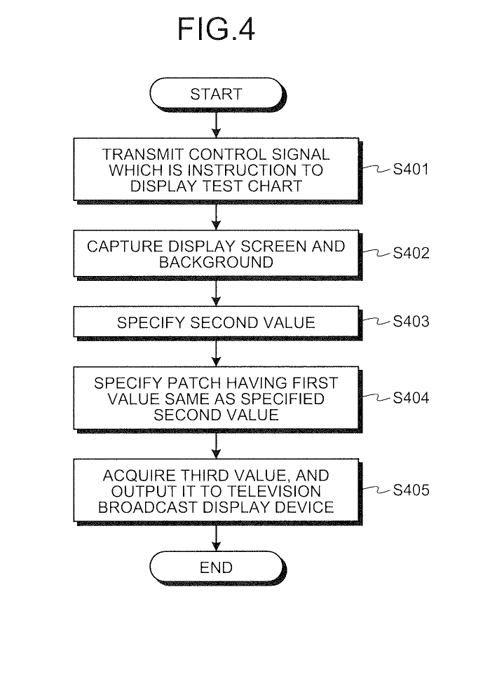

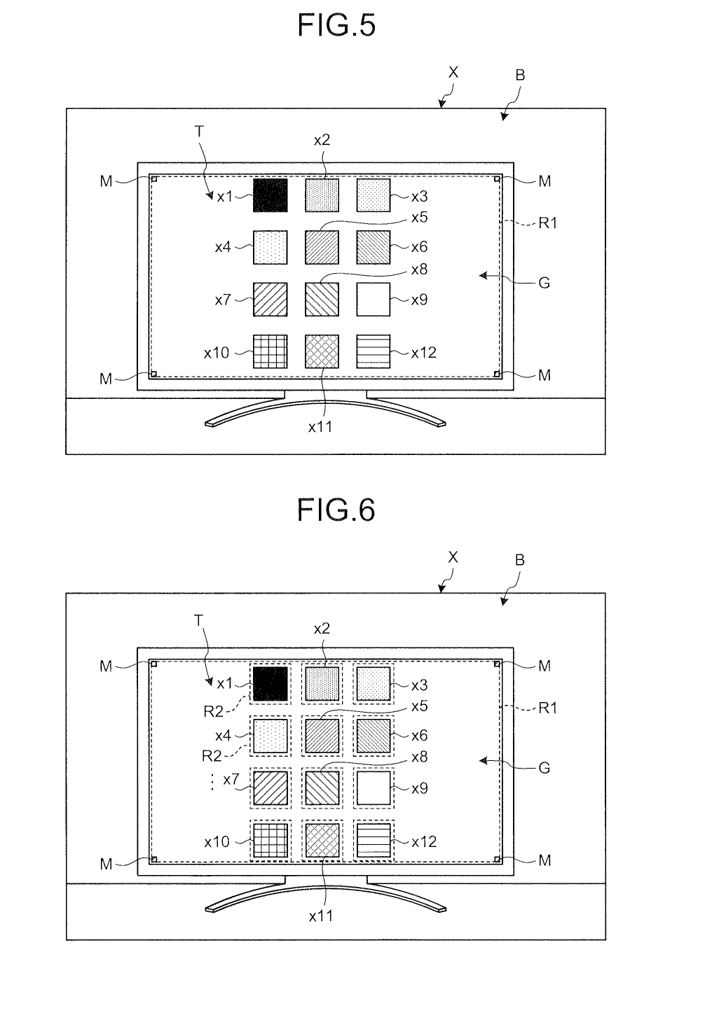

Next, with reference to FIGS. 4 to 6, there is described in details an output processing of the third value in the mobile terminal device 2 in the embodiment. FIG. 4 is a flowchart of the output processing of the third value in the mobile terminal device in the first embodiment. FIGS. 5 and 6 are views illustrating an example of the captured image obtained through image capturing by the image capturing module provided in the mobile terminal device in the first embodiment.

When an adjustment of the brightness, the color temperature, or the color of the display screen G provided in the television broadcast display device 1 is instructed by a user operation through the mobile terminal device 2, the acquisition module 410 transmits a control signal which is an instruction to display the test chart T (see FIG. 5) to the television broadcast display device 1 through the communication module 25 before the image capturing module 24 performs the image capturing (S401).

After transmitting of the control signal, the acquisition module 410 prepares the image capturing module 24 so as to be in a state capable of capturing the display screen G provided in the television broadcast display device 1 and the background of the display screen G (for example, a wall on the rear surface side of the television broadcast display device 1). When the image capturing is instructed by a user operation through the mobile terminal device 2, the image capturing module 24 captures the entire display screen G and the background B of the display screen G (S402). The acquisition module 410 thereby obtains the captured image X containing the entire display screen G and the background B of the display screen G. In the embodiment, the image capturing module 24 captures the entire display screen G, but it is sufficient that the image capturing module 24 captures at least a portion of the display screen G so as to be able to specify parameters of patches x1 to x12 arranged on the test chart T (see FIG. 5), as an example of the image having a parameter of a predetermined value.

In the embodiment, as illustrated in FIG. 5, the image capturing module 24 captures the display screen G and the background B. The display screen G displays the test chart T on which a plurality of patches x1 to x12 are arranged in the grid form. Each of the patches x1 to x12 has different predetermined value of a parameter, which is one of the brightness, the color temperature, and the color. The test chart T comprises the patches x1 to x6 having different brightnesses (an example of the predetermined values), the patches x7 to x9 having different color temperatures (predetermined values), and the patches x10 to x12 having different colors (predetermined values). In the embodiment, among the patches x1 to x12 arranged on the test chart T, the patches x1 to x6 having different brightnesses are achromatic, and the patches x7 to x12 having different colors (or color temperatures) are chromatic. In the following description, the patches x1 to x12 are referred to as patches xn (n is an integer 1 to 12) when there is no need to distinguish them.

After acquiring the captured image X, the acquisition module 410 performs a processing of outputting the parameter information to the television broadcast display device 1 through the communication module 25 based on the acquired captured image X. It is described first an output processing of the parameter information of when the acquisition of the brightness of the background B of the display screen G is instructed by the user operation through the mobile terminal device 2. In the following description, the processing of acquiring the brightness of the background B of the display screen Gas the third value is described. It is to be noted that the processing of acquiring the color temperature or the color of the background B of the display screen G is performed in the same manner.

The acquisition module 410 specifies, from the captured image X, the second value of the brightness (parameter) of the background B contained in the captured image X (S403). Here, the brightness of the second value is the same type of parameter as the parameter of the first value of the brighness (parameter) of the patch xn arranged on the test chart T contained in the captured image X (S403).

In the embodiment, as illustrated in FIG. 5, the acquisition module 410 detects a position specification display M displayed on the display screen G of the television broadcast display device 1 from the captured image X. Here, the position specification display M can specify a position of the display screen G. Then, the acquisition module 410 detects a region R1 surrounded by the detected position specification display M as the display screen G, and detects a region outside the region R1 as the background B.

The acquisition module 410 specifies a weighted average as the second value of the brightness (parameter) of the background B. The weighted average is obtained by weighing values representing the brightness (parameter) in the vicinity of the display screen G among values representing the brightness (parameter) of the detected background B. Although the acquisition module 410 specifies the weighted average of the values representing the brightness (parameter) of the detected background B as the second value of the brightness (parameter) of the background B in the embodiment, the second value is not limited thereto. For example, the acquisition module 410 may specify an average of the values representing the brightness (parameter) of the detected background B as the second value of the brightness of the background B, or may specify the value representing the brightness (parameter) in the vicinity of the display screen G as the second value of the brightness of the background B.

Subsequently, the acquisition module 410 specifies a patch xn having the first value the same as the specified second value of the brightness (parameter) of the background B among the patches x1 to x12 arranged on the test chart T contained in the display screen G detected in the captured image X (S404).

To be more specific, as illustrated in FIG. 6, the acquisition module 410 first detects a plurality of regions R2 arranged in the grid form in the display screen G detected in the captured image X. The acquisition module 410 recognizes images on the respective regions R2 as the patches x1 to x12 arranged on the test chart T. Furthermore, the acquisition module 410 selects the achromatic patches x1 to x6 as the patches x1 to x6 having different brightnesses (predetermined values) from the recognized patches x1 to x12. Subsequently, the acquisition module 410 compares the brightnesses (first values) of the selected patches x1 to x6 that are represented by captured-image RGB values that are combinations of signal values of the respective colors of RGB, with the brightness (second value) of the background B specified at S403. The acquisition module 410 thereby specifies a patch xn having brightness (first value) the same as the brightness (second value) of the background B.

Furthermore, when there is no patch xn having the same brightness (first value) as the brightness (second value) of the background B, the acquisition module 410 specifies a plurality of patches xn having the brightnesses (first values) close to the brightness (second value) of the background B. To be more specific, the acquisition module 410 specifies a patch xn having a brightness (first value) the closest to but lower than the brightness (second value) of the background B and a patch xn having a brightness (first value) the closest to but lighter than the brightness (second value) of the background B.

Next, when the patch xn having the same brightness (first value) as the brightness (second value) of the background B contained in the captured image X is specified, the acquisition module 410 acquires the brightness of the predetermined value of the specified patch xn as the brightness (third value) of the background B of the display screen G, and outputs the acquired brightness (third value) as the parameter information to the television broadcast display device 1 (S405).

The captured image X obtained through image capturing by the image capturing module 24 provided in the mobile terminal device 2 is generally added with effects of characteristics unique to the image capturing module 24, such as the kind of the image capturing module 24 and automatic correction functions of the image capturing module 24. The automatic correction functions include automatic brightness correction of correcting the brightness automatically and automatic white balance of correcting the white balance automatically. For this reason, the characteristics unique to the image capturing module 24 need to be considered (in other words, the characteristics unique to the image capturing module 24 need to be cancelled) in order to acquire the accurate brightness, color temperature, or color of the background B of the display screen G of the television broadcast display device 1.

The acquisition module 410 computes the amount of change in the brightness of the patch xn on the captured image X due to the characteristics unique to the image capturing module 24 based on the brightness (particular value) of the patch xn arranged on the test chart T (an example of the image having the parameter of the predetermined value) and the brightness of the first value of the patch xn contained in the captured image X (brightness of the patch xn with the characteristics unique to the image capturing module 24). The amount of change in the brightness of the patch xn in the captured image X due to the characteristics unique to the image capturing module 24 is a difference between the brightness (particular value) of the patch xn arranged on the test chart T (an example of the image) and the brightness of the first value of the patch xn contained in the captured image X (brightness of the patch xn with effects of the characteristics unique to the image capturing module 24), for example. The acquisition module 410 acquires (estimates) the brightness as the third value of the background B of the display screen G (brightness without effects of the characteristics unique to the image capturing module 24) from the brightness (second value) of the background B contained in the captured image X based on the obtained amount of change.

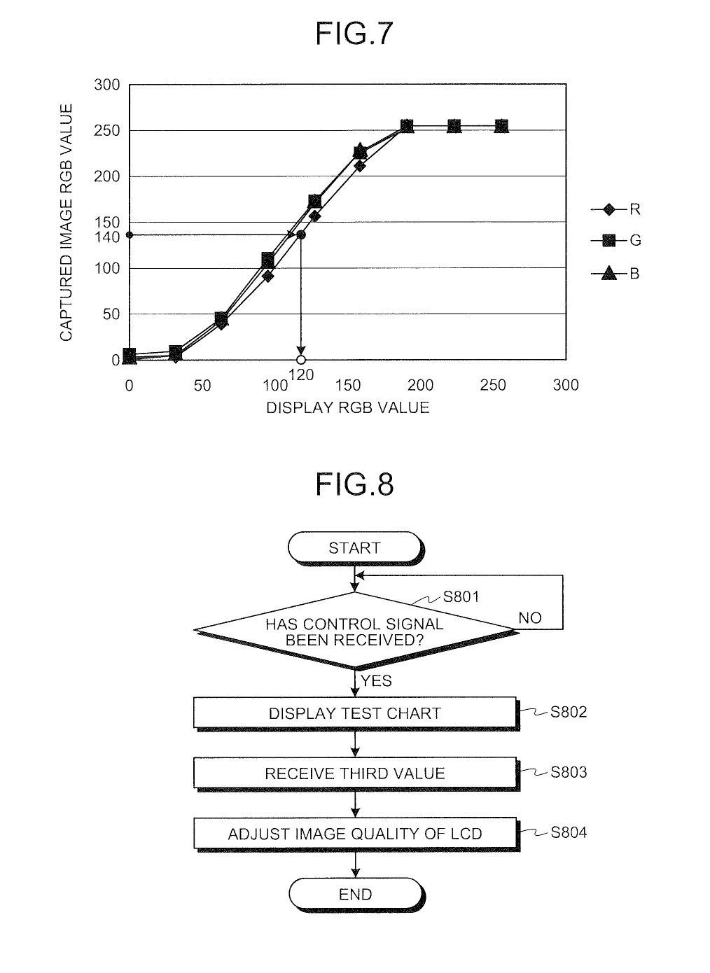

In the embodiment, the mobile terminal device 2 stores an RGB value conversion table in the storage module 26. The RGB value conversion table correlates a captured-image RGB value and a display RGB value with each other. The captured-image RGB value is a combination of signal values of colors of RGB of the patche xn arranged on the test chart T contained in the captured image X. The display RGB value is a combinations of signal values of colors of RGB of the patche xn arranged on the test chart T displayed on the display screen G. In other words, the display RGB values are signal values representing the predetermined values (reference values) of the brightnesses, the color temperatures, or the colors of the patches xn arranged on the test chart T. FIG. 7 is a graph illustrating the correspondence between the captured-image RGB values and the display RGB values on the RGB value conversion table stored in the mobile terminal device in the first embodiment. In the embodiment, the RGB value conversion table correlates the captured-image RGB values and the display RGB values with each other as illustrated in FIG. 7. For example, on the RGB value conversion table, an R signal value of 140 contained in the captured-image RGB values correlates to an R signal value of 120 contained in the display RGB values, as illustrated in FIG. 7.

When specifying the patch xn with the first value of the brighness that is the same as the second value of the brighness of the background B contained in the captured image X, the acquisition module 410 reads out a display RGB value correlated to the captured-image RGB value of the specified patch xn from the RGB value conversion table. The acquisition module 410 acquires the brightness (predetermined value) represented by the read display RGB value as the brightness (third value) of the background B of the display screen G, and outputs the acquired brightness to the television broadcast display device 1. Although the acquisition module 410 reads out the display RGB values from the RGB value conversion table stored in the storage module 26 in the embodiment, the acquisition module 410 may read out the display RGB values from the RGB value conversion table stored in a server (not illustrated) connected through a network.

Furthermore, when specifying the patches xn having the brightnesses (first values) close to the brightness (second value) of the background B contained in the captured image X, the acquisition module 410 reads out a plurality of display RGB values correlated with the captured-image RGB values of the specified patches xn from the RGB value conversion table. The acquisition module 410 uses the read display RGB values to interpolate the display RGB value of a virtual patch having the same brightness (first value) as the brightness (second value) of the background B contained in the captured image X, thereby acquiring the brightness represented by the interpolated display RGB values as the brightness (third value) of the background B of the display screen G. That is to say, the acquisition module 410 specifies the patches xn having the brightnesses (first values) close to the brightness (second value) of the background B contained in the captured image X. The acquisition module 410 uses the brightnesses (predetermined values) of the specified patches xn to interpolate the brightness (particular value) of a virtual patch having the brightness (second value) of the background B contained in the captured image X, thereby acquiring the interpolated brightness (particular value) as the third value.

To be more specific, the acquisition module 410 reads out, from the RGB value conversion table, two display RGB values. One of the display RGB values is correlated with a captured-image RGB value of a patch xn (for example, patch x1) having the brightness (first value) the closest to but darker (lower) than the brightness (second value) of the background B. Other one of the display RGB values is correlated with a captured-image RGB value of a patch xn (for example, patch x2) having the brightness (first value) the closest to but lighter (higher) than the brightness (second value) of the background B. The acquisition module 410 uses the two readout display RGB values to interpolate a display RGB value of a virtual patch having the same brightness (first value) as the brightness (second value) of the background B contained in the captured image X, thereby acquiring the brightness (particular value) expressed by the interpolated display RGB value as the brightness (third value) of the background B of the display screen G.

In the embodiment, the acquisition module 410 outputs the brightness (third value) of the background B of the display screen G to the television broadcast display device 1. The acquisition module 410 may output, instead of the brightness itself of the background B of the display screen G, parameter information as a reference for the brightness (third value) of the background B of the display screen G.

For example, the acquisition module 410 may be configured to output, as parameter information, information including: the first value of the brightness, which is that of the display screen G contained in the captured image X; and the second value of the brighness, which is that of the background B contained in the captured image X. In this case, the television broadcast display device 1 may acquire the third value by performing the same processing as in the acquisition module 410. Alternatively, the acquisition module 410 may output, as the parameter information, the relation between the first value of the brightness, which is that of the display screen G contained in the captured image X, and the second value of the brighness, which is that of the background B contained in the captured image X. To be more specific, the relation indicates that the brightness (first value) of the display screen G contained in the captured image X is lighter (higher) than the brightness (second value) of the background B contained in the captured image X or that the brightness (first value) of the display screen G contained in the captured image X is darker (lower) than the brightness (second value) of the background B contained in the captured image X, for example. Alternatively, the acquisition module 410 may output the captured image X obtained through the image capturing by the image capturing module 24 to the television broadcast display device 1, and all of the processing by the acquisition module 410 may be performed on the television broadcast display device 1 side. In this case, the television broadcast display device 1 functions as an information processor.

Next, with reference to FIG. 8, a processing of adjusting the brightness, the color temperature, or the color of the display screen G in the television broadcast display device 1 in the embodiment is described in details. FIG. 8 is a flowchart of the processing of adjusting the image quality of the display screen provided in the television broadcast display device in the first embodiment.

The receiver 401 shifts to an adjustment-dedicated mode in which the brightness, color temperature, and color of the display screen G are adjusted to standard states, and waits to receive a control signal which is an instruction to display the test chart T from the mobile terminal device 2 (No at S801). When the receiver 401 receives the control signal (Yes at S801), the display controller 402 displays the test chart T on the display screen G (S802). When displaying the test chart T on the display screen G, the display controller 402 displays the test chart T on the display screen G in a state where the display conditions of the display screen G have been initialized by adjusting the white balance and the like of the display screen G.

After the test chart T is displayed on the LCD 102, the receiver 401 receives the third value (the brightness, the color temperature, or the color of the display screen G) transmitted from the mobile terminal device 2 (S803).

When the receiver 401 receives the third value, the display controller 402 adjusts the image quality such as the brightness, the color temperature, the color, and the sharpness of the display screen G provided in the television broadcast display device 1 based on the received third value (S804). For example, when the brightness of the background B received as the third value is lighter than the brightness of a video image on the display screen G, the display controller 402 displays the lighter video image. Furthermore, when the color temperature of the background received as the third value is higher than the color temperature of the video image on the display screen G, the display controller 402 sets the higher color temperature of the video image.

Thus, the mobile terminal device 2 in the first embodiment makes it possible to acquire the brightness, the color temperature, or the color of the background B of the display screen G by considering the characteristics unique to the image capturing module 24 (by cancelling the characteristics unique to the image capturing module 24). This enables acquisition of the accurate brightness, color temperature, or color of the background B of the display screen G.

A second embodiment is an example in which brightnesses, color temperatures, and colors of patches arranged on the test chart are measured to acquire a third value by using the measured brightnesses, color temperatures, and colors of the patches in a mobile terminal device. In the following description, description of the same parts as those in the first embodiment is omitted.

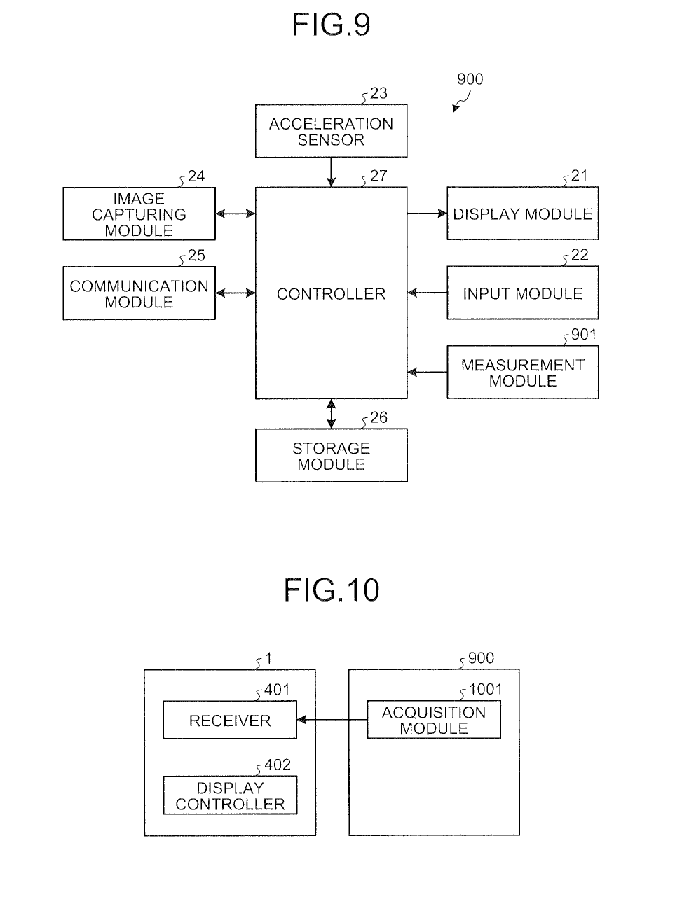

FIG. 9 is a diagram illustrating an example of a hardware configuration of the mobile terminal device in the second embodiment. As illustrated in FIG. 9, this mobile terminal device 900 in the embodiment comprises the display module 21, the input module 22, the acceleration sensor 23, the image capturing module 24, the communication module 25, the storage module 26, the controller 27, and a measurement module 901.

The measurement module 901 measures brightnesses (cd/m²), color temperatures (K), and colors (XYZ values) as predetermined values of the respective patches xn arranged on the test chart T displayed on the display screen G of the television broadcast display device 1, before the image capturing module 24 performs image capturing of the display screen G and the background of the display screen G.

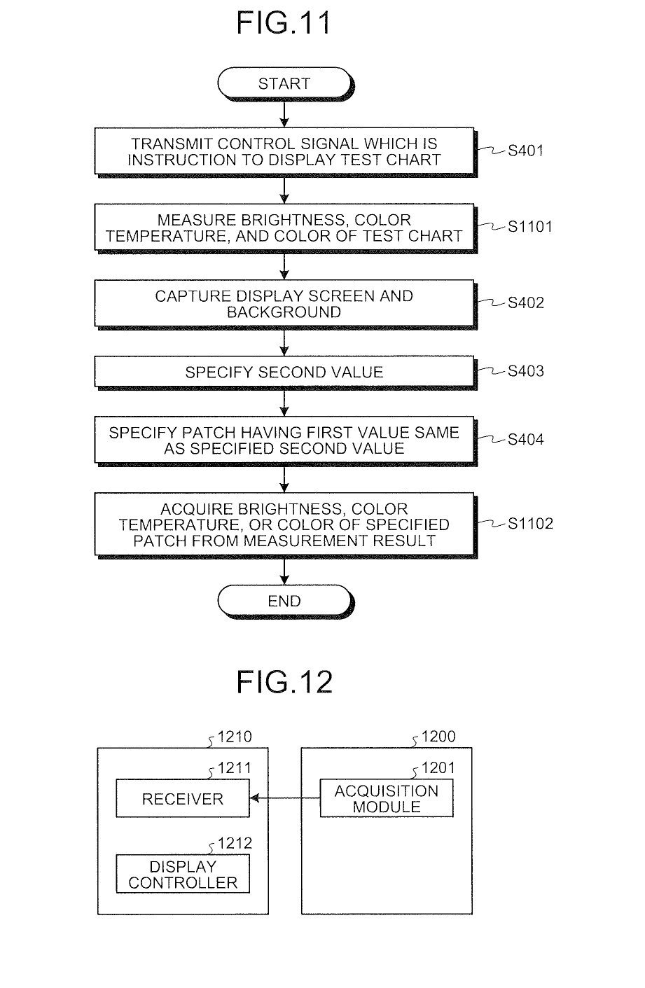

FIG. 10 is a block diagram illustrating the functional configurations of the television broadcast display device and the mobile terminal device in the second embodiment. FIG. 11 is a flowchart illustrating an output processing of the third value in the mobile terminal device in the second embodiment. The controller 27 of the mobile terminal device 900 in the embodiment executes programs stored in the storage module 26 so as to implement an acquisition module 1001 as illustrated in FIG. 10. In the following description, the processing of acquiring the brightness of the background B of the display screen G as the third value is described. Here, the processing of acquiring the color temperature or the color of the background B of the display screen G as the third value is performed in the same manner.

In the mobile terminal device 900 in the embodiment, the measurement module 901 measures the brightnesses (cd/m²), color temperatures (K), and colors (XYZ values) as the predetermined values of the respective patches x1 to x12 arranged on the test chart T displayed on the display screen G provided in the television broadcast display device 1, before the image capturing module 24 performs image capturing of the display screen G and the background of the display screen G (S1101).

When acquisition of the brightness of the background B of the display screen G is instructed by the user operation through the mobile terminal device 900, the acquisition module 1001 acquires the brightness of the patch xn specified at S404 from the brightnesses (particular values) of the patches x1 to x12 that are the measurement results by the measurement module 901, and outputs the acquired brightness (particular value) as the brightness (third value) of the background B of the display screen G to the television broadcast display device 1 (S1102). Although the acquisition module 1001 acquires the brightness of the patch xn specified at S404 from the measurement results by the measurement module 901 provided in the mobile terminal device 900 in the embodiment, the configuration is not limited thereto. The brightnesses (cd/m²), color temperatures (K), and colors (XYZ values) as predetermined values of the patches x1 to x12 arranged on the test chart T displayed on the display screen G provided in the television broadcast display device 1 may be measured with an external measurement device such as a luminance meter before the television broadcast display device 1 is shipped or the like. In this case, the measurement result may be stored in a server, the television broadcast display device 1, or the like to which the mobile terminal device 900 can access through a network, and the brightness of the patch xn specified at S404 may be acquired from the measurement result stored in the server, the television broadcast display device 1, or the like. More accurate predetermined values can be acquired by measuring the particular values with the dedicated measurement device such as the luminance meter. When the particular values are measured by the external measurement device, the processing at S1101 is performed by the external measurement device.

As described above, the mobile terminal device 900 in the second embodiment makes it possible to acquire the brightness, the color temperature, or the color of the background B of the display screen G in consideration of the characteristics unique to the image capturing module 24, thereby acquiring the accurate brightness, color temperature, or color of the background B of the display screen G as in the first embodiment.

A third embodiment is an example in which the brightnesses, color temperatures, and colors of patches arranged on a plurality of test charts to be displayed in a switching manner are measured so as to acquire a third value by using the measured brightnesses, color temperatures, and colors of the patches in a mobile terminal device. In the following description, description of the same parts as those in the second embodiment is omitted.

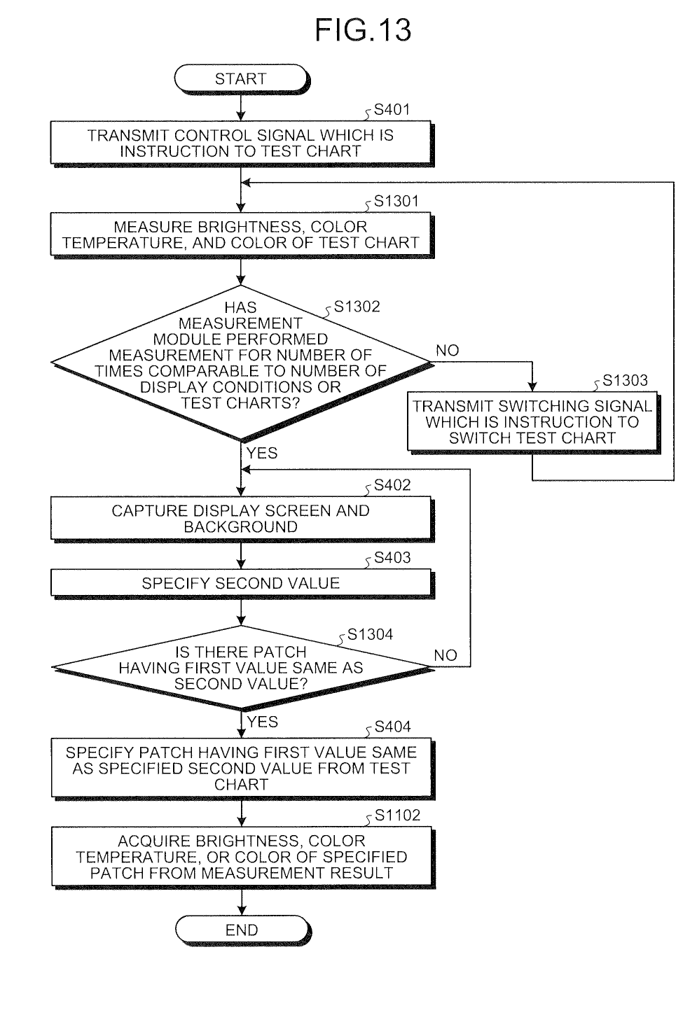

FIG. 12 is a block diagram illustrating functional configurations of a television broadcast display device and a mobile terminal device in the third embodiment. FIG. 13 is a flowchart illustrating the output processing of the third value in the mobile terminal device in the third embodiment. The controller 27 of a mobile terminal device 1200 in the embodiment executes programs stored in the storage module 26 so as to implement an acquisition module 1201, as illustrated in FIG. 12. Furthermore, in a television broadcast display device 1210 in the embodiment, a controller (not illustrated) executes a display control application so as to implement a receiver 1211 and a display controller 1212, as illustrated in FIG. 12.

Every time the measurement module 901 measures the brightnesses (cd/m²), color temperatures (K), and colors (XYZ values) as particular values of the patches x1 to x12 arranged on the test charts T (S1301), the acquisition module 1201 transmits a switching signal that is an instruction to switch the test chart T to the television broadcast display device 1 (S1303).

The receiver 1211 of the television broadcast display device 1210 receives the switching signal transmitted from the mobile terminal device 1200. When the receiver 1211 receives the switching signal from the mobile terminal device 2, the display controller 1212 of the television broadcast display device 1210 switches the test chart T displayed on the display screen G to a test chart T on which patches xn having brightnesses, color temperatures, or colors as particular values that are different from those of the patches xn arranged on the displayed test chart T are arranged.

In the embodiment, the television broadcast display device 1210 stores therein the test charts T on which the patches xn having different brightnesses, color temperatures, or colors are arranged, and displays the test charts T in a switching manner in accordance with the received switching signal. Furthermore, the display controller 1212 may display the test charts T on which the patches xn having different brightnesses, color temperatures, or colors are arranged in the switching manner by changing display conditions (for example, brightness, color temperature, and color) of the test chart T to be displayed on the display screen G in accordance with the switching signal received from the mobile terminal device 2. In the embodiment, the display controller 1212 displays the test charts T on which the patches xn having different brightnesses, color temperatures, or colors are arranged on the display screen G. Alternatively, the display controller 1212 may display one patch xn (image having a parameter of a particular value) having a different brightness, color temperature, or color on the display screen G in the switching manner.

The measurement module 901 repeats the measurement of the brightnesses (cd/m²), color temperatures (K), and colors (XYZ values) of the patches arranged on the test chart T for the number of times comparable to the number of test charts stored in the television broadcast display device 1210 or to the number of display conditions that can be changed on the television broadcast display device 1210 (No at S1302). After the measurement module 901 repeats the measurement for the number of times comparable to the number of test charts T stored in the television broadcast display device 1210 or to the number of display conditions that can be changed on the television broadcast display device 1210 (Yes at S1302), the process proceeds to S402. When measuring the particular values, the external measurement device performs the pieces of processing at S1301 to S1303.

The image capturing module 24 repeats image capturing of the test charts T on which the patches xn having different predetermined values are arranged and are displayed in the switching manner (or the test charts T are displayed in the switching manner with the display conditions changed) (No at S1304) until the acquisition module 1201 specifies a patch xn having the first value the same as the specified second value (Yes at S1304). That is to say, the captured image X obtained through the image capturing by the image capturing module 24 is obtained by capturing the display screen G displaying the test charts T on which the patches xn having different particular values are arranged in the switching manner and the background B, or is obtained by capturing the display screen G displaying the test charts T having different display conditions and the background B.

As described above, the mobile terminal device 1200 in the third embodiment makes it possible to specify the patch xn having the first value that is close to the second value of the parameter of the background B contained in the captured image X by capturing the display screen G displaying the test charts on which patches xn having different particular values are arranged in the switching manner while the brightness, the color temperature, or the color is set as the parameter. This enables acquisition of the brightness, the color temperature, or the color of the background B of the display screen G with higher accuracy.

As described above, the first to third embodiments make it possible to acquire the accurate brightness, color temperature, or color of the background B of the display screen G.

Programs to be executed in the television broadcast display device and the mobile terminal device in the embodiments are provided in advance by being incorporated in a read-only memory (ROM) or the like. Alternatively, the programs may be provided by being recorded in a computer-readable recording medium, such as a compact disc read only memory (CD-ROM), a flexible disk (FD), a CD recordable (CD-R), or a digital versatile disk (DVD), in an installable or executable file format.

The programs to be executed in the television broadcast display device and the mobile terminal device in the embodiments may be provided by being stored on a computer connected to a network such as the Internet and being downloaded through the network. Alternatively, the programs to be executed in the television broadcast display device and the mobile terminal device in the embodiments maybe provided or distributed through a network such as the Internet.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processor comprising:
an acquisition module configured to acquire a third value of a parameter based on a first value of the parameter, a second value of the parameter, and a predetermined value, wherein
the parameter is one of a brightness, a color temperature, and a color,
a type of the parameter of the second value and a type of the parameter of the third value are same as a type of the parameter of the first value,
the first value is a value of the parameter corresponding to a test chart of a display screen comprised in a captured image obtained by capturing the display screen and the background of the display screen by an image capturing module,
the test chart comprises a parameter of the predetermined value,
the second value is a value of the parameter of the background comprised in the captured image, and
the third value is a value of the parameter of the background.

2. The information processor of claim 1, wherein
the test chart comprises a plurality of patches comprising different predetermined values, and
the acquisition module is configured to specify some of the patches each comprising the first value close to the second value from the captured image, configured to interpolate the predetermined value of the patch corresponding to the second value by using some of the predetermined values of the some of the patches specified, and configured to acquire the interpolated predetermined value as the third value.

3. The information processor of claim 2, wherein the captured image is obtained by capturing the background and the display screen displaying a plurality of test charts on which the patches comprising the different predetermined values are arranged in a switching manner.

4. The information processor of claim 1, wherein the captured image is obtained by capturing the background and the display screen displaying a plurality of test charts comprising different display conditions.

5. The information processor of claim 1, wherein the second value is a weighted average obtained by weighing a value of the parameter of the background in the vicinity of the display screen contained in the captured image.

6. An information processing method performed by an information processor, the information processing method comprising:
acquiring, by an acquisition module, a third value of a parameter based on a first value of the parameter, a second value of the parameter, and a predetermined value, wherein
the parameter is one of a brightness, a color temperature, and a color,
a type of the parameter of the second value and a type of the parameter of the third value are same as a type of the parameter of the first value,
the first value is a value of the parameter corresponding to a test chart of a display screen comprised in a captured image obtained by capturing the display screen and the background of the display screen by an image capturing module,
the test chart comprises a parameter of the predetermined value,
the second value is a value of the parameter of the background comprised in the captured image, and
the third value is a value of the parameter of the background.
